(19) United States
(12) Patent Application Publication
(10) Pub. No.: US 2006/0273927 A1
(43) Pub. Date: Dec. 7, 2006

(54) Obstacle detection device for vehicle

(75) Inventor: Yoshihisa Sato, Nagoya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/441,202

(22) Filed: May 26, 2006

(30) Foreign Application Priority Data
Jun. 1, 2005 (JP) 2005-161792

(51) Int. Cl. G08G 1/01

(52) U.S. Cl. 340/933

(57) ABSTRACT

An obstacle detection device for a vehicle includes multiple obstacle detection units which are respectively arranged at predetermined positions of the vehicle, a communication line connected with the obstacle detection units, an informing unit connected with the communication line, and a control unit which is connected with one end of the communication line to receive obstacle detection information sent by the obstacle detection units via the communication line. The control unit controls the informing unit so that the informing unit indicates an obstacle detection when an obstacle has been detected, based on the obstacle detection information. The control unit controls the informing unit via the communication line.

### CROSS REFERENCE TO RELATED APPLICATION

This application is based on a Japanese Patent Application No. 2005-161792 filed on Jun. 1, 2005, the disclosure of which is incorporated herein by reference.

### FIELD OF THE INVENTION

The present invention relates to an obstacle detection device for detecting an obstacle around a vehicle, for example.

### BACKGROUND OF THE INVENTION

Generally, for example, referring to U.S. Pat. No. 6,897,768-B2 (JP-3565200-B2), an obstacle detection device for a vehicle is provided with multiple obstacle detection sensors which are connected with a bus from an ECU. The ECU is communicated with each of the obstacle detection sensors via the bus.

Specifically, the ECU sends instruction signals via the bus to each of the obstacle detection sensors, so that the obstacle detection sensor sends ultrasound to the exterior to detect an obstacle around the vehicle. Moreover, the obstacle detection sensor having detected the obstacle sends information about the obstacle to the ECU via the bus, to reduce the wiring number as compared with the case where the ECU is connected with the obstacle detection sensors respectively via different communication lines.

The obstacle detection device is provided with an informing unit for notifying the obstacle information to a driver of the vehicle when the obstacle is detected. According to comparison examples with reference to FIGS. 15A-15C, the informing unit (e.g., indicator) is constructed of multiple LED. Based on which LED lights up, the position (with respect to vehicle) of the obstacle which is detected can be recognized. FIG. 15A shows that the each LED mounted at the indicator is directly controlled via the ECU. FIG. 15B shows that the indicator and the ECU are connected with an existing LAN mounted at the vehicle, and the ECU controls the indicator via the existing LAN. FIG. 15C shows that the ECU controls the indicator via a dedicated serial communication.

However, according to the construction shown in FIG. 15A, the ECU directly controls the each LED arranged at the indicator, so that the wiring number between the indicator and the ECU increases. According to the constructions shown in FIGS. 15B and 15c, it is necessary to respectively provide the communication units for the ECU and the indicator for the communication between the ECU and the indicator so that the cost becomes high. Moreover, according to the construction shown in FIG. 15B, the ECU and the indicator is to be connected with the existing LAN of the vehicle. In this case, it is difficult to retrofit the obstacle detection device to the vehicle after the vehicle is sold.

### SUMMARY OF THE INVENTION

In view of the above-described disadvantages, it is an object of the present invention to provide an obstacle detection device for a vehicle, in which multiple obstacle detection units are connected with a control unit via a bus to reduce a wiring number and a cost for a connection of an informing unit. The obstacle detection device is ready for a retrofitting at the vehicle.

According to the present invention, an obstacle detection device for a vehicle is provided with a plurality of obstacle detection units which are respectively arranged at predetermined positions of the vehicle to perform obstacle detections in a plurality of detection areas, a communication line which is connected with the plurality of obstacle detection units, an informing unit which is connected with the communication line, and a control unit which is connected with one end of the communication line to receive obstacle detection information sent by the plurality of obstacle detection units via the communication line. The control unit controls the informing unit so that the informing unit informs an obstacle detection when an obstacle has been detected, based on the obstacle detection information. The control unit controls the informing unit via the communication line.

Thus, it is unnecessary to arrange a dedicated communication line between the control unit and the informing unit, so that the wiring number is reduced. Moreover, the communication portion (communication line) for communicating the control unit and the informing unit doubles as a communication portion between the control unit and the obstacle detection unit. Thus, the cost is reduced. Furthermore, because it is unnecessary to connect with an existing LAN of the vehicle, the obstacle detection device can be readily mounted at the vehicle after the vehicle is purchased.

Preferably, the informing unit is connected with the communication line at one of a foremost stage and a final stage of the communication unit, with respect to the one end of the communication line where the control unit is connected.

Generally, the obstacle detection unit is arranged at an outer surface of the vehicle, for example, a bumper, and the informing unit is mounted in a passenger compartment and positioned near a driver seat. Thus, if the informing unit and the obstacle detection unit are connected with each other via a communication line, it is necessary to take the communication line into the passenger compartment from the exterior of the vehicle and take the communication line to the exterior of the vehicle again. Therefore, the wiring waste increases. According to the present invention, the informing unit is arranged at the foremost stage or the final stage of the communication line, thus reducing the wiring waste.

More preferably, ID setting of the plurality of obstacle detection units is performed by the control unit via the communication line after the obstacle detection units are mounted at the vehicle. The plurality of obstacle detection units are connected to the communication line in sequence. Among the plurality of obstacle detection units, the obstacle detection unit which is arranged at a foremost stage of the communication line with respect to the control unit is firstly ID-set in such a manner that a communication between the control unit and the obstacle detection unit of the foremost stage is solely capable among the plurality of obstacle detection units. The other obstacle detection units than the foremost-stage obstacle detection unit are sequentially communicated with the control unit to be ID-set, in such a manner that a communication between the control unit and the sequent-stage obstacle detection unit is made capable by the fore-stage obstacle detection unit which has been ID-set by the control unit. Based on an ID setting sequence of the plurality of obstacle detection units, the control unit assigns the plurality of obstacle detection units to the arrangement positions to identify the plurality of obstacle detection units. The control unit performs an ID setting of the informing unit along with the ID setting of the obstacle detection units. After the ID setting of the informing unit is completed, the informing unit makes capable the communication between the control unit and the foremost-stage obstacle detection sensor, which is connected to the communication line at a sequent stage with respect to the informing unit.

Thus, after the ID setting of the informing unit is completed, the informing unit makes capable the communication between the control unit and the foremost-stage obstacle detection unit which is arranged at the sequent stage with respect to the informing unit. Accordingly, the ID setting of the informing unit can be performed along with that of the obstacle detection unit.

### BRIEF DESCRIPTION OF THE DRAWINGS

Other objects, features and advantages of the present invention will become more apparent from the following detailed description made with reference to the accompanying drawings, in which:

FIG. 1 is a block diagram showing a construction of an obstacle detection device for a vehicle according to a first embodiment of the present invention;

FIG. 2 is a schematic diagram showing an interior construction of an ECU according to the first embodiment;

FIG. 3 is a schematic diagram showing an interior construction of an indicator/sensor and connections thereof with a power line, a GND line and a communication line according to the first embodiment;

FIG. 4 is a diagram showing a format of a communication frame between the ECU and the indicator and that between the ECU and the sensor according to the first embodiment;

FIG. 5 is a flow chart shows processes performed by the ECU, the indicator and the sensors when ID setting of the indicator and the sensors is performed according to the first embodiment;

FIG. 6 is a schematic diagram showing an arrangement of the indicator, the ECU and the sensors at the vehicle in the case where the indicator is connected with a foremost stage of the communication line according to the first embodiment;

FIG. 7 is a block diagram showing a construction of an obstacle detection device for a vehicle where an indictor is connected with a final stage of a communication line according to a modification of the first embodiment;

FIG. 8 is a schematic diagram showing an arrangement of the indicator, an ECU and sensors at the vehicle in the case where the indicator is connected with the final stage of the communication line according to the modification of the first embodiment;

FIG. 9 is a block diagram showing a construction of an obstacle detection device for a vehicle according to a second embodiment of the present invention;

FIG. 10 is a schematic diagram showing an interior construction of an ECU according to the second embodiment;

FIG. 11 is a schematic diagram showing an interior construction of an ECU according to a modification of the second embodiment;

FIG. 12 is a flow chart showing processes performed by the ECU, an indicator and sensors when ID setting of the indicator and the sensors is performed according to the second embodiment;

FIG. 13 is a schematic diagram showing an arrangement of the indicator, the ECU and the sensors at the vehicle in the case where the indicator is connected with a communication line via a lead according to the second embodiment;

FIG. 14 is a block diagram showing a construction of an obstacle detection device for a vehicle according to a third embodiment of the present invention; and

FIGS. 15A, 15B and 15C are schematic diagrams which respectively show constructions of vehicle obstacle detection devices according to different comparison examples.

### DETAILED DESCRIPTION OF THE EXAMPLE EMBODIMENTS

### First Embodiment

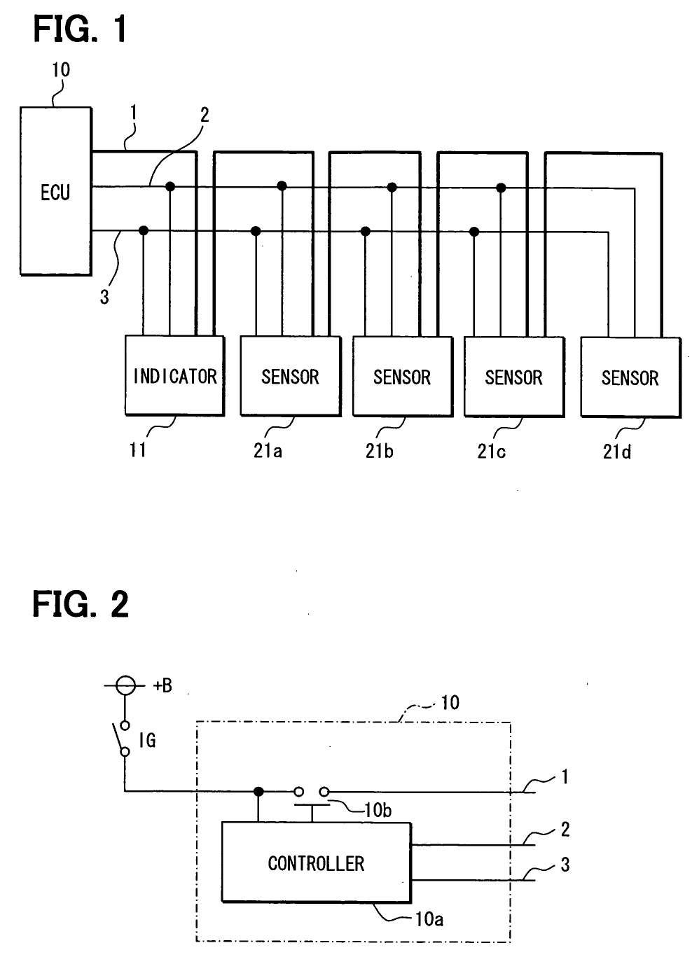

An obstacle detection device for a vehicle according to a first embodiment of the present invention will be described with reference to FIGS. 1-8. As shown in FIG. 1, the obstacle detection device includes an informing unit 11 (e.g., indicator), multiple obstacle detection units (e.g., sensors 21a-21d) and a control unit 10 (e.g., ECU), which is connected with the informing unit 11 and the obstacle detection units.

The ECU 10 controls operations of the sensors 21-21d and the indicator 11, which are connected with a communication line 3. Specifically, for example, the ECU 10 controls (instructs) the sensors 21a-21d so that the sensors 21a-21d send signals (e.g., ultrasound pulse signals) for detecting an obstacle to the exterior at a predetermined timing. Moreover, obstacle position information detected by each of the sensors 21a-21d is sent to the indicator 11, to be indicated by the indicator 11.

The ECU 10 provides (sets) ID for the indicator 11 and the sensors 21a-21d, for example, after the indicator 11 and the sensors 21a-21d are mounted at the vehicle, so as to control the operations of the indicator 11 and the sensors 21a-21d. In this case, the indicator 11 and the sensors 21a-21d are not beforehand provided with ID before being mounted at the vehicle.

As shown in FIG. 2, the ECU 10 has therein a controller 10a which is power-supplied by a vehicle-mounted battery +B via an ignition switch IG. Two ends of a switch 10b are respectively connected with the vehicle-mounted battery +B via the ignition switch IG and a power line 1. In this case, the controller 10a is capable of controlling opening/closing of the switch 10b. That is, the controller 10a controls a power supply for the power line 1. A GND line 2 and a communication line 3 are drawn from the controller 10a.

The indicator 11 includes, for example, multiple LED (light-emitting diode) and a controller which controls the driving of the multiple LED. Based on the obstacle position information sent by the ECU 10, the indicator 11 determines which LED is to be made light up. According to the LED which lights up, a driver of the vehicle can be informed the position (with respect to vehicle) where the obstacle is detected.

The sensors 21a-21d are respectively arranged at predetermined positions of the vehicle to perform obstacle detections in a plurality of detection areas around the vehicle, for example. The sensor 21a-21d can be constructed of an ultrasound sensor which produces ultrasound pulses and sends the ultrasound pulses to the exterior. According to reflection wave of the ultrasound pulses, the sensor 21a-21d determines whether or not there exits an obstacle in the detection area. In the case where it is determined that there exits the obstacle around the vehicle, the sensor 21a-21d calculates a distance between the vehicle and the obstacle.

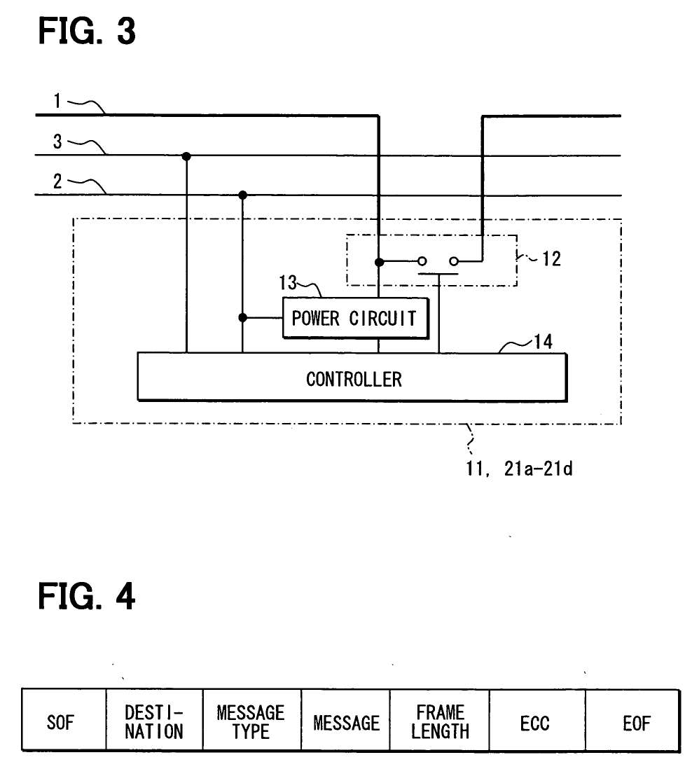

As shown in FIG. 3, each of the indicator 11 and the sensors 21a-21d is provided therein with a controller 14, a power circuit 13 and a switch 12. The power line 1 from the ECU 10 is connected in line with each of the switches 12 of the indicator 11 and the sensors 21-21d. That is, one end and other end of each of the switches 12 are respectively connected with an upstream side of the power line 1 and a downstream side thereof.

In each of the indicator 11 and the sensors 21a-21d, the power circuit 13 is connected with the one end of the switch 12 and the GND line 2 which is drawn from the ECU 10, to be used as a power source of the controller 14. The controller 14 is connected in line (bus connection) with the GND line 2 drawn from the ECU 10 and the communication line 3, to control ON/OFF of the switch 12.

Moreover, as shown in FIG. 1, the indicator 11 is connected with foremost stages of the power line 1, the GND line 2 and the communication line 3 which are drawn from the ECU 10. The sensors 21-21d are connected with the power line 1, the GND line 2 and the communication line 3 at the sequent stages of the indicator 11.

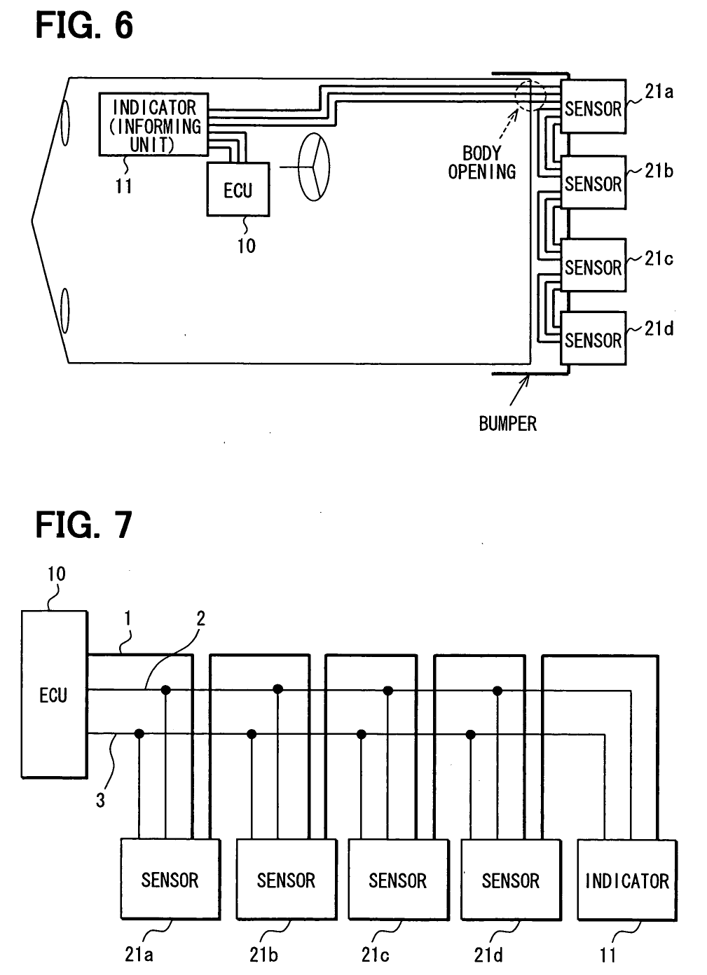

Referring to FIG. 6, the ECU 10 and the indicator 11 are arranged near a driving seat of the vehicle. The sensors 21a-21d are mounted at, for example, a rear bumper of the vehicle, and respectively positioned at a right portion, a facade and a left portion of the rear bumper.

FIG. 4 shows a format of a communication frame between the ECU 10 and each of the indicator 11 and the sensors 21a-21d. The one frame includes fields of a Start of Frame (SOF), a destination, a message type, a message, a frame length, an Error Check Cord (ECC) and an End of Frame (EOF).

In the case where the communication frame is an ID setting message which is sent from the ECU 10 to set ID for the indicator 11 or the sensor 21a-21d, a broadcast address is set in the destination field of the communication frame, a “ID setting” is set in the message type field thereof, and an ID to be set (i.e., ID which will be provided for indicator 11 or sensor 21a-21d) is set in the message field thereof.

Moreover, in the case where the communication frame is an ID-setting completion message for replying the ECU 10 from the indicator 11 or the sensor 21a-21d, the address of the ECU 10 is set in the destination field of the communication frame, an “ID-setting completion” is set in the message type field thereof, and the ID having been set is set in the message field thereof.

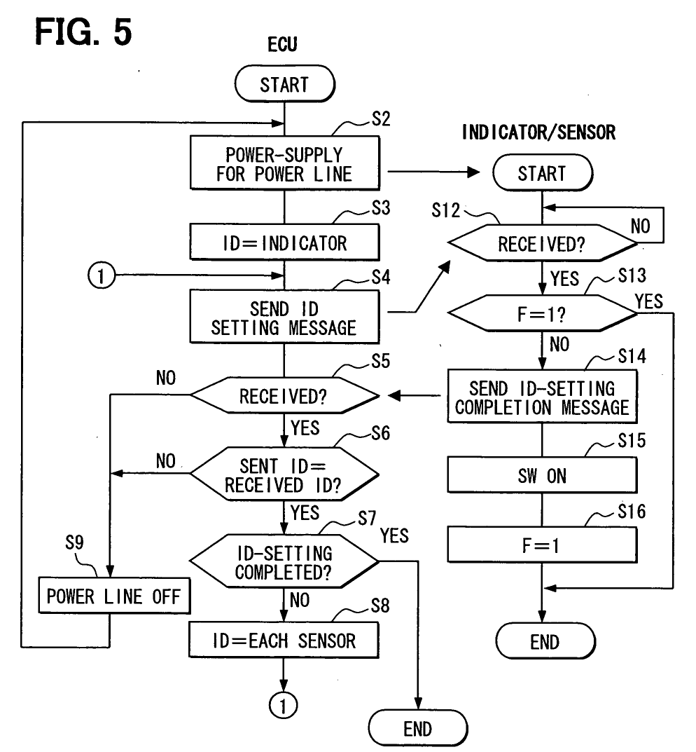

Next, referring to FIG. 5, the processes performed by the ECU 10, the indicator 11 and the sensors 21a-21d when the ID setting of the indicator 11 and the sensors 21a-21d is performed will be described. In this case, the ECU 10 beforehand memorizes in a memory (not shown) thereof the ID responding to the arrangement positions (e.g., right portion, facade and left portion of rear bumper) of the sensors 21a-21d. Thus, when the ID setting of the sensors 21a-21d is performed by the ECU 10, the ID is set in sequence from the ID responding to the right portion of the rear bumper, for example. That is, the ECU 10 identifies (recognizes) the sensors 21a-21d by assigning the sensors 21a-21d to the arrangement positions according to the ID setting sequence.

Referring to FIG. 5, when the ignition switch IG of the vehicle becomes ON so that the ECU 10 is power-supplied by the vehicle-mounted battery +B, the process of the controller 10a of the ECU 10 is started. For the simplification, the controller 10a of the ECU 10 will be indicated as the ECU 10 in the following.

At first, at step S2, the ECU 10 makes the switch 10b ON so that the power line 1 is power-supplied by the vehicle-mounted battery +B. Thus, the controller 14 of the indicator 11 which is arranged at the foremost stage is power-supplied via the power line 1, so that the process of the indicator 11 is started and step S12 will be performed. For the simplification, the controller 14 of the indicator 11 will be indicated as the indicator 11 in the following.

Then, at step S3, the ECU 10 sets the ID to be set as an indicator use. At step S4, the ECU 10 sends the ID setting message where the ID is set, to the communication line 3. At step S5, the ECU 10 waits for the ID-setting completion message from the indicator 11 (or sensor 21a-21d). That is, the ECU 10 determines whether or not the ID-setting completion message is received.

As described above, when the ignition switch IG of the vehicle becomes ON, the indicator 11 is power-supplied so that the process of the indicator 11 is started. Thus, at step S12, the indicator 11 determines whether or not the ID setting message sent at step S4 is received.

When the indicator 11 receives the ID setting message, step S13 will be performed. At step S13, the indicator 11 determines whether or not an ID-setting-message disregarding flag F is set (that is, F=1). In the case where the ID-setting-message disregarding flag F is not set (that is, F≠1), step S14 will be performed. On the other hand, in the case where the ID-setting-message disregarding flag F is set (that is, F=1), the ID setting message having been received is disregarded and the process shown in FIG. 5 performed by the indicator 11 is ended. On the other hand, when it is determined that the ID setting message sent at step S4 is not received, step S12 will be repeated by the indicator 11.

In this case, the ID-setting-message disregarding flag F is a flag, which is provided with an initial value F=0 and set as F=1 by the sensors 21a-21d and the indicator 11 which have been provided with the ID.

At step S14, the ID in the ID setting message having been received is memorized, and then the ID-setting completion message where the ID is set is sent. Then, at step S15, the switch 12 of the indicator 11 becomes ON, so that the sensor 21a which is arranged at the sequent stage with respect to the indicator 11 is power-supplied to start the process thereof (i.e., sensor 21a waits for ID setting message for use of sensor 21a from ECU 10). That is, the sensor 21a of the sequent stage is power-supplied to commence operating. In this case, the indicator 11 where the ID setting has been completed, disregards the ID setting messages for the sensors 21a-21d of the sequent stage.

Thereafter, at step S16, the ID-setting-message disregarding flag F is set (that is, F=1). Then, the process performed by the indicator 11 is ended.

On the other hand, at step S5, the ECU 10 determines whether or not the ID-setting completion message from the indicator 11 or the sensor 21a-21d is received. In the case where the ID-setting completion message is received, step S6 will be performed. On the other hand, in the case where the ID-setting completion message is not received at step S5, step S9 will be performed.

At step S6, the ECU 10 determines whether or not the ID in the ID setting message having been sent is equal to that in the ID-setting completion message having been received. In the case where the ID in the ID setting message having been sent is equal to that in the ID-setting completion message having been received, step S7 will be performed. On the other hand, in the case where the ID in the ID setting message having been sent is not equal to that in the ID-setting completion message having been received, step S9 will be performed.

At step S9, it is determined that the ID setting is faulty, so that the power line 1 is made OFF. Then, the process will be returned to step S2 so that the power line 1 becomes ON again and the ID setting is performed over again from the indicator 11 arranged at the foremost stage. Thus, the error setting of the ID due to engine noise or the like can be restricted.

At step S7, the ECU 10 determines whether or not the ID setting till the sensor 21d arranged at the final stage (final stage) is completed. In the case where the ID setting of the sensor 21d is not completed, step S8 will be performed. At step S8, the ID is set as the use for the sequent-stage sensor 21a, for example. That is, the ID is set as that corresponding to the right portion of the rear bumper, for example.

Then, the process is returned to step S4. At step S4, the ID setting message where the ID is set is sent via the communication line 3 so that the ID setting of the sensor 21a of the sequent stage is performed.

Similarly, the ID setting of the sensor 21b, 21c, and 21d is performed. In the case where it is determined at step S7 that the ID setting till the sensor 21d of the final stage is completed, the ID setting process shown in FIG. 5 is ended.

Thereafter, the indicator 11 and the sensors 21a-21d where the ID has been set are individually communicated with the ECU 10 via the communication line 3, by setting the ID of a communication companion (that is, other end of communication) in the destination field of the communication frame. For example, the ECU 10 sends to each of the sensors 21a-21d a message for instructing the sensor 21a-21d to send the ultrasound pulses to the exterior to detect an obstacle.

Thus, in the case where an obstacle is detected by the sensor 21a-21d, the sensor having detected the obstacle sends to the ECU 10 the information of the distance between the vehicle and the obstacle. Thereafter, the ECU 10 which has received the information of the distance between the vehicle and the obstacle sends to the indicator 11 a message for instructing which LED is to be made light up. Based on this message, the indicator 11 makes the corresponding LED light up. Accordingly, the driver can be informed where the obstacle exists.

According to this embodiment, the indicator 11 is connected to the foremost stage of the communication line 3. Because the ID setting of the indicator 11 is performed in concert with the ID setting of the sensors 21a-21d, the communication between the ECU 10 and the indicator 11 can be performed via the communication line 3. Therefore, the wiring number can be reduced.

Moreover, because it is unnecessary to provide the ECU 10 with a dedicated communication unit for communicating the ECU 10 with the indicator 11, the cost can be reduced. Furthermore, because other already-existing LAN is not used, the obstacle detection device can be readily mounted at the vehicle. However, when the indicator 11 is connected to the foremost stage of the communication line 3 as described in this embodiment, these advantages are effective in the case where the ECU 10 is positioned near the indicator 11 as shown in FIG. 6 (where both of ECU 10 and indicator 11 are arranged at vehicle front portion). The reason is that the length of the communication line 3 can be shortened. That is, because the indicator 11 is generally arranged close to the driver seat, these advantages are effective in the case where the ECU 10 is arranged at the vehicle front portion.

In the first embodiment, as shown in FIG. 6, the sensors 21a-21d are arranged at the rear bumper. However, the sensors 21a-21d can be also mounted at any other positions of the vehicle, for example, at a front bumper of the vehicle.

Moreover, in this embodiment, the power line 1 is connected in line with each of the switches 12, and the controller 14 is constantly connected in line (bus connection) with the GND line 2 and the communication line 3. However, the GND line 2 or the communication line 3 can be also connected in line with each of the switches 12.

Next, a modification of the first embodiment will be described.

In the first embodiment, the indicator 11 is connected with the foremost stage of the communication line 3, so as to restrict a waste of the wiring (including power line 1, GND line 2 and communication line 3). That is, if the indicator 11 is connected to a portion between the sensors 21a-21d, the wiring is to be arranged from the rear bumper (where sensors 21a-21d are mounted) via the vicinity of the driver seat (where indicator 11 is mounted) again to the rear bumper. Therefore, the waste of the wiring will become large.

According to the modification, as shown in FIG. 7, the indicator 11 can be also connected with the final stage of the communication line 3, so as to restrict the wiring waste. In this case, when the ID of the indicator 11 and the sensors 21a-21d is set, the initial value of the ID is set as the ID for the use of the sensor 21a at step S3 shown in FIG. 5. Thus, the ID setting of the sensors 21a-21d is performed before that of the indicator 11. That is, the ID setting of the indicator 11 is performed at last. In this case, because nothing is to be connected with the sequent stage of the indicator 11, it is unnecessary to provide the switch 12 for the indicator 11.

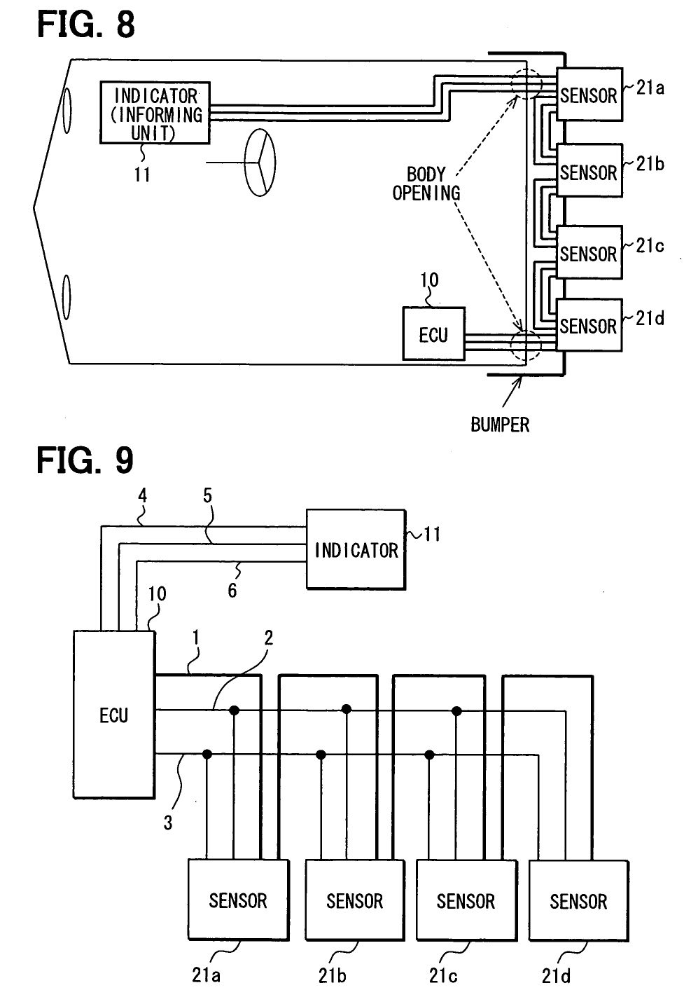

When the indicator 11 is connected with the communication line 3 at the final stage of the communication line 3, the restriction of the wiring waste is effective in the case where the sensor 21a-21d is mounted near the ECU 10, for example, as shown in FIG. 8 where the sensors 21a-21d and the ECU 10 are arranged at the vehicle rear portion.

### Second Embodiment

According to the above-described first embodiment, the indicator 11 is directly connected with the communication line 3, and the ID setting of the indicator 11 and the operation control of the indicator 11 is performed via the communication line 3. However, the communication line 3 will become long, for example, in the case where the ECU 10 is mounted near the center portion of the vehicle, the indicator 11 is mounted near the driver seat and the sensors 21a-21d are arranged at the rear bumper. That is, the communication line 3 will become long due to the mounting positions of the ECU 10, the indicator 11 and the sensors 21a-21d.

According to a second embodiment of the present invention, the indicator 11 is indirectly connected with the communication line 3 via a lead 6 which is drawn from the communication line 3. That is, the indicator 11 is not directly connected with the communication line 3. The ID setting of the indicator 11 and the control of the indicator 11 are performed via the lead 6 and the communication line 3.

As shown in FIG. 9, the indicator 11 is connected with a power line 4 drawn from the ECU 10, a GND line 5 and the lead 6. Similar to the first embodiment, the sensors 21a-21d are directly connected with the communication line 3, and connected in line through the power line 1 respectively via the switches 12 thereof.

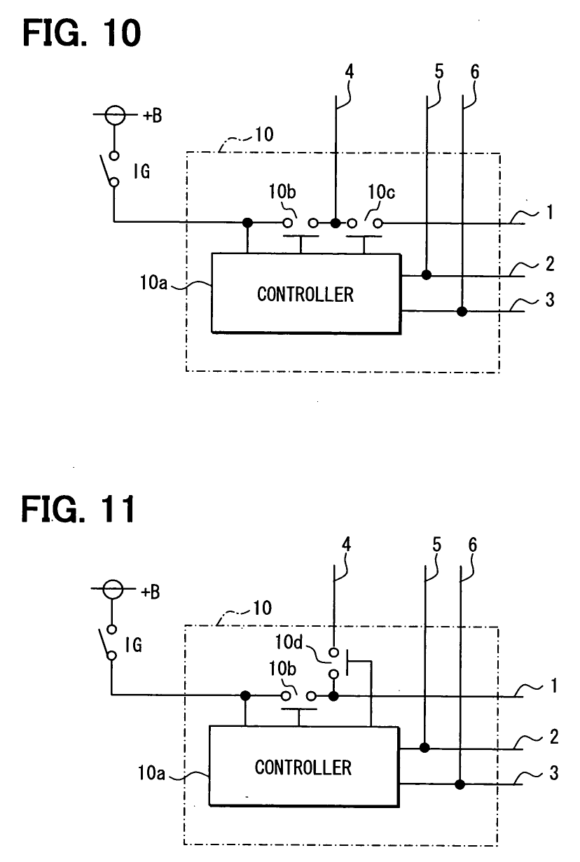

In this case, referring to FIG. 10, the ECU 10 is provided with a switch 10c other than the switch 10b. The switches 10c and 10b are arranged at the power line 1. Opening/closing of the switch 10c is controlled by the controller 10a.

Moreover, one end of the power line 4 is connected to the portion between the switch 10b and the switch 10c at the power line 1, one end of the GND line 5 is connected with the GND line 2, and one end of the lead 6 is connected with the communication line 3. That is, the indicator 11 is indirectly connected with the communication line 3 via the lead 6. Thus, when the switch 10b is made ON by the controller 10a so that the power line 4 is power-supplied, the ECU 10 can communicate with the indicator 11. Furthermore, when the switch 10c becomes ON, the power line 1 is power-supplied so that the ECU 10 can communicate with the sensor 21a.

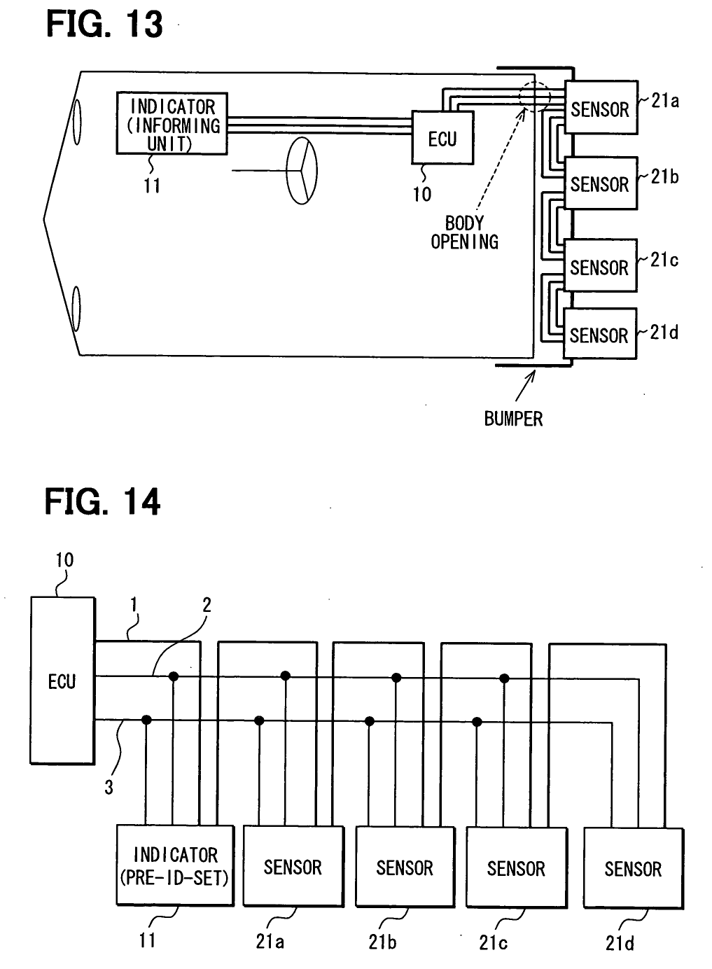

The ECU 10, the indicator 11 and the sensors 21a-21d are arranged at the vehicle, for example, as shown in FIG. 13. That is, the indicator 11 is mounted near the driver seat. The sensors 21a-21d are arranged in sequence at the right portion, the facade and the left portion of the rear bumper. The ECU 10 is mounted at the vehicle rear portion.

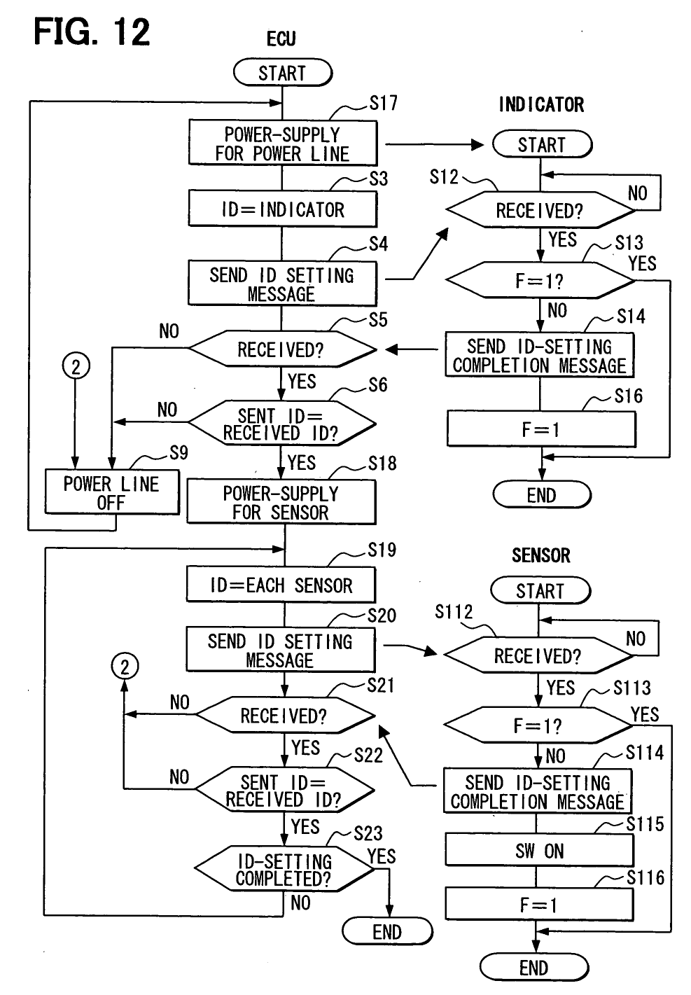

Next, referring to FIG. 12, the processes performed by the ECU 10, the indicator 11 and the sensors 21a-21d when the ID of the indicator 11 and the sensors 21a-21d is set will be described.

When the ignition switch IG of the vehicle becomes ON, the controller 10a of the ECU 10 is power-supplied by the vehicle battery +B to commence operating. For simplification, the controller 10a of the ECU 10 will be indicated as the ECU 10 in following.

At first, at step S17, the switch 10b is made ON by the ECU 10, so that the indicator 11 is power-supplied. In this case, the switch 10c is kept OFF. Thus, the controller 14 of the indicator 11 is power-supplied to commence operating.

Then, at step S3, the ECU 10 sets the ID as the indicator use. Similarly to the first embodiment, the ECU 10 sets the ID for the indicator 11 (at steps S4-S6, S12-S16 referring to FIG. 12). Because it is unnecessary for the indicator 11 to connect the sensor of the sequent stage to the power line 1 after the ID setting of the indicator 11 is performed (as described in first embodiment), the process of step S15 shown in FIG. 5 is not performed in the second embodiment.

As described above, at step S6, the ECU 10 determines whether or not the ID in the ID setting message having been sent is equal to that in the ID-setting completion message having been received. In the case where the ID in the ID setting message having been sent is not equal to that in the ID-setting completion message having been received, step S9 will be performed.

On the other hand, in the case where the ECU 10 determines at step S6 that the ID in the ID setting message having been sent is equal to that in the ID-setting completion message having been received, step S18 will be performed.

At step S18, the ECU 10 makes the switch 10c ON so that the sensor 21a is power-supplied. Thus, the process of the sensor 21a is started, and step S112 is performed.

At step S19, the ECU 10 sets the ID as the use for the sensor 21a. At step S20, the ECU 10 sends the ID setting message where the ID is set, to the communication line 3.

On the other hand, at step S112, the sensor 21a (which is power-supplied to start process thereof) determines whether or not the ID setting message sent by the ECU 10 at step S20 is received. That is, the sensor 21a waits for the ID setting message sent from the ECU 10.

When it is determined that the sensor 21a has received the ID setting massage, step S113 will be performed. At step S113, the sensor 21a determines whether or not an ID-setting-message disregarding flag F is set (that is, F=1). In the case where the ID-setting-message disregarding flag F is not set (that is, F=1), step S114 will be performed. On the other hand, in the case where the ID-setting-message disregarding flag F is set (that is, F=1), the ID setting message having been received is disregarded and the process performed by the sensor 21a is ended. When the ID setting massage has not been received by the sensor 21a, step S112 will be repeated.

At step S114, the ID in the ID setting message having been received is memorized, and then the ID-setting completion message including this ID is sent. Then, the switch 12 of the sensor 21a becomes ON at step S115, so that the sensor 21b of the further sequent stage is power-supplied to start the process thereof (that is, sensor 21b waits for ID setting message for use of sensor 21b). In this case, the sensor 21a where the ID setting has been completed, disregards the ID setting messages for the sensors 21b-21d of the further sequent stage.

Thereafter, at step S116, the ID-setting-message disregarding flag F is set (that is, F=1). Then, the process of the sensor 12a is ended.

On the other hand, after step S20 is performed, the ECU 10 will perform step S21. At step S21, the ECU 10 waits for the ID-setting completion message from the senor 21a. That is, the ECU 10 determines whether or not the ID-setting completion message from the sensor 21a is received.

In the case where it is determined that the ECU 10 has received the ID-setting completion message, step S22 will be performed. On the other hand, in the case where it is determined that the ID-setting completion message is not received by the ECU 10, step S9 will be performed.

At step S22, the ECU 10 determines whether or not the ID in the ID setting message having been sent is equal to that in the ID-setting completion message having been received. In the case where the ID in the ID setting message having been sent is equal to that in the ID-setting completion message having been received, step S23 will be performed. On the other hand, in the case where the ID in the ID setting message having been sent is not equal to that in the ID-setting completion message having been received, step S9 will be performed.

At step S9, it is determined that the ID setting is faulty, so that the power line 1 is made OFF. Then, the process will be returned to step S17, so that the switch 10b is made ON by the ECU 10 and the indicator 11 is power-supplied. Thus, the ID setting is performed over again from the indicator 11. Thus, the error setting of the ID due to engine noise or the like can be restricted.

At step S23, the ECU 10 determines whether or not the ID setting till the sensor 21d arranged at the final stage (final stage) is completed. In the case where the ID setting till the sensor 21d is not completed, the process will be performed from step S19 again. At step S19, the ID is set as the use for the further sequent sensor 21b, for example. On the other hand, when it is determined that the ID setting till the sensor 21d has been completed, the process will be ended.

Similarly to what described above, the ID setting of the sensor 21b, 21c, and 21d is performed. That is, the ID setting of the sensors 21a-21d is sequentially performed.

Then, the ECU 10 can individually communicate with the indicator 11 and the sensors 21a-21d. In this case, the communication between the ECU 10 and the indicator 11 is performed via the communication line 3 and the lead 6.

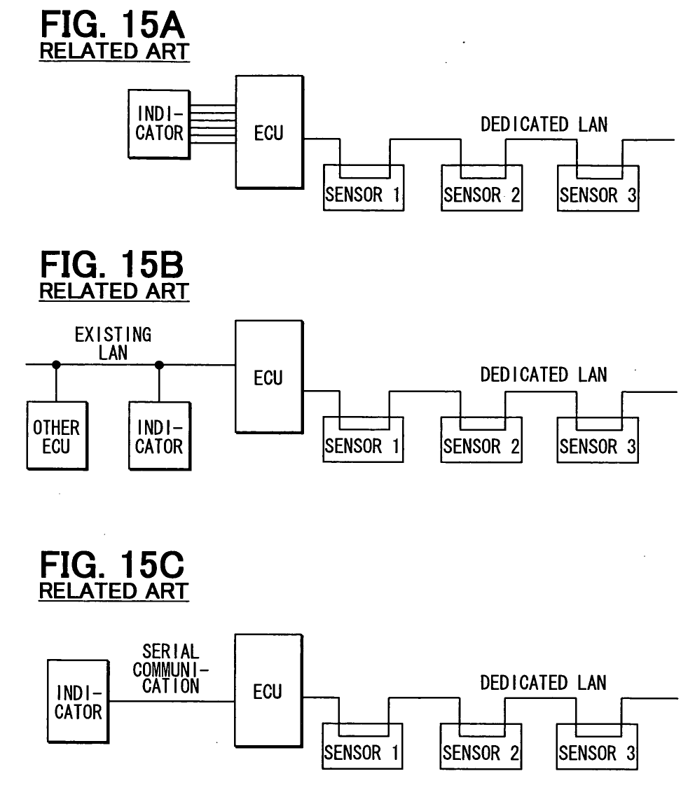

According to the second embodiment, because the communication between the ECU 10 and the indicator 11 is performed via the communication line 3 of the sensor use (similarly to first embodiment), it is unnecessary to provide the ECU 10 with a communication portion (as shown in FIGS. 15B and 15C) specialized for the communication with the indicator 11. Thus, the cost can be reduced.

As compared with the first embodiment, the wring number increases due to the arrangement of the power line 4, the GND 5 and the lead 6 according to the second embodiment. However, for example, in the case where the ECU 10, the indicator 11 and the sensors 21a-21d are arranged as shown in FIG. 13, the whole wiring length can be shortened as compared with the case where the indicator 11 is connected to the foremost stage of the communication line 3 (referring to first embodiment). That is, as compared with the first embodiment, the whole wiring length can be shortened by arranging the ECU 10, the indicator 11 and the sensors 21a-21d as described in the second embodiment.

Furthermore, even when the ECU 10 is arranged at the rear portion of the vehicle, it is necessary to make the wiring pass two body openings (which are respectively arranged at vehicle right portion and vehicle left portion) to mount the sensors 21a-21d at the rear bumper as shown in FIG. 8, in the case where the indicator 11 is connected with the final stage of the communication line 3 referring to the modification of the first embodiment. According to the second embodiment, referring to FIG. 13, the wiring is to pass only one body opening. Thus, the mounting of the sensors 21a-21d at the vehicle can be simplified.

In the second embodiment, the switch 10c is arranged at the power line 1. The switch 10c is switched between ON and OFF to make the communication between the ECU 10 and the sensor 21a capable/incapable. Alternatively, the switch 10c can be also arranged at the GND line 2 or the communication line 3, so that the ECU 10 makes the communication with the sensor 21a capable/incapable.

Next, a modification of the second embodiment will be described.

In the second embodiment, the ID setting of the indicator 11 is firstly performed before the ID setting of the sensors 21a-21d, by providing the switch 10c for the ECU 10. Because the ID of the indicator 11 has been set firstly, the indicator 11 can disregard the ID setting message when the ID setting of the sensors 21a-21d is performed via the ID setting message.

According to the modification of the second embodiment, the communication between the ECU 10 and the indicator 11 is made incapable when the ID setting of the sensors 21a-21d is performed. In this case, the ID setting of the indicator 11 is performed at last.

As shown in FIG. 11, the ECU 10 is provided therein with a switch 10d at the power line 4. Thus, in the ID setting, the switch 10c is made ON so that the power line 1 is power-supplied to firstly set the ID of the sensors 21a-21d at step S18 shown in FIG. 12. In this case, the switch 10d is controlled by the ECU 10 to be OFF so that the communication between the ECU 10 and the indicator 11 is incapable. After the ID setting of all the sensors 21a-21d is completed, the ECU 10 makes the switch 10d ON so that the indicator 11 is power-supplied and the ID setting of the indicator 11 is performed.

In this case, the switch 10d can be also arranged at the GND line 5 or the lead 6.

In the second embodiment and the modification thereof, what has not been described about the obstacle detection device is the same with the first embodiment.

### Third Embodiment

According to the above-described first and second embodiments, the ID setting of the indicator 11 and the sensors 21a-21d is performed after the indicator 11 is mounted at the vehicle.

According to a third embodiment of the present invention, referring to FIG. 14, the indicator 11 where the ID is beforehand set before being mounted at the vehicle can be also used. In this case, the ID setting for the sensors 21a-21d is performed after the indicator 11 is mounted at the vehicle, similarly to what described above.

According to the third embodiment, the indicator 11 can be connected to the communication line 3 at the foremost stage or the final stage of the communication line 3. Alternatively, the indicator 11 can be also connected to the communication line 3 via the lead line, as described in the second embodiment. Thus, the same effects with those of the first embodiment or the second embodiment can be obtained.

In the third embodiment, what has not been described about the obstacle detection device is the same with the first embodiment.

What is claimed is:

1. An obstacle detection device for a vehicle, comprising:
a plurality of obstacle detection units which are respectively arranged at predetermined positions of the vehicle to perform obstacle detections in a plurality of detection areas;
a communication line which is connected with the plurality of obstacle detection units;
an informing unit which is connected with the communication line; and
a control unit which is connected with one end of the communication line to receive obstacle detection information sent by the plurality of obstacle detection units via the communication line, wherein
the control unit controls the informing unit via the communication line so that the informing unit indicates an obstacle detection when an obstacle has been detected, based on the obstacle detection information.

2. The obstacle detection device according to claim 1, wherein the plurality of obstacle detection units and the informing unit are directly connected with the communication line.

3. The obstacle detection device according to claim 2, wherein
the informing unit is connected with the communication line at one of a foremost stage and a final stage of the communication unit, with respect to the one end of the communication line where the control unit is connected.

4. The obstacle detection device according to claim 3, wherein
a distance between the control unit and the informing unit is smaller than that between the control unit and the obstacle detection unit, in the case where the informing unit is connected with the communication line at the foremost stage thereof.

5. The obstacle detection device according to claim 3, wherein
a distance between the control unit and the obstacle detection unit is smaller than that between the control unit and the informing unit, in the case where the informing unit is connected with the communication line at the final stage thereof.

6. The obstacle detection device according to claim 2, wherein:
the plurality of obstacle detection units are ID-set by the control unit via the communication line after the obstacle detection units are mounted at the vehicle;
the plurality of obstacle detection units are connected to the communication line in sequence;
among the plurality of obstacle detection units, the obstacle detection unit which is arranged at a foremost stage of the communication line with respect to the control unit is firstly ID-set in such a manner that a communication between the foremost-stage obstacle detection unit and the control unit is solely capable among communications between the plurality of obstacle detection units and the control unit;
the other obstacle detection units than the foremost-stage obstacle detection unit are sequentially communicated with the control unit to be ID-set, in such a manner that the communication between the control unit and the sequent-stage obstacle detection unit is made capable by the fore-stage obstacle detection unit which has been ID-set by the control unit;
based on an ID setting sequence of the plurality of obstacle detection units, the control unit assigns the plurality of obstacle detection units to the arrangement positions to identify the plurality of obstacle detection units;
the control unit performs an ID setting of the informing unit along with the ID setting of the obstacle detection units; and
after the ID setting of the informing unit is completed, the informing unit makes capable the communication between the control unit and the foremost-stage obstacle detection sensor, which is connected to the communication line at a sequent stage with respect to the informing unit.

7. The obstacle detection device according to claim 1, further comprising
a lead, through which the informing unit is indirectly connected with the communication line, the lead being drawn from the communication line.

8. The obstacle detection device according to claim 7, further comprising
a switch which is connected with the control unit to make capable/incapable a communication between the control unit and the informing unit, wherein:
the plurality of obstacle detection units are ID-set by the control unit via the communication line after the obstacle detection units are mounted at the vehicle;
the plurality of obstacle detection units are connected to the communication line in sequence;
among the plurality of obstacle detection units, the obstacle detection unit which is arranged at a foremost stage of the communication line with respect to the control unit is firstly ID-set in such a manner that a communication between the foremost-stage obstacle detection unit and the control unit is solely capable among communications between the plurality of obstacle detection units and the control unit;
the other obstacle detection units than the foremost-stage obstacle detection unit are sequentially communicated with the control unit to be ID-set, in such a manner that the communication between the control unit and the sequent-stage obstacle detection unit is made capable by the fore-stage obstacle detection unit which has been ID-set by the control unit;
based on an ID setting sequence of the plurality of obstacle detection units, the control unit assigns the plurality of obstacle detection units to the arrangement positions to identify the plurality of obstacle detection units;
when the ID setting of the plurality of the obstacle detection units is sequentially performed, the control unit controls the switch to make incapable the communication between the control unit and the informing unit; and
after the ID setting of the plurality of the obstacle detection units is completed, the control unit controls the switch to make capable the communication between the control unit and the informing unit so as to perform the ID setting of the informing unit.

9. The obstacle detection device according to claim 8, further comprising:
a power line; and
a GND line, the informing unit being power-supplied via the GND line and the power line, wherein
the switch is arranged at one of the power line and the GND line.

10. The obstacle detection device according to claim 8, wherein the switch is arranged at the lead.

11. The obstacle detection device according to claim 7, further comprising
a switch which is connected with the control unit to make capable/incapable a communication between the control unit and the foremost-stage obstacle detection unit, the foremost-stage obstacle detection unit being connected to the communication line at a foremost stage with respect to the control unit among the plurality of obstacle detection units, wherein:
the plurality of obstacle detection units are ID-set by the control unit via the communication line after the obstacle detection sensors are mounted at the vehicle;
the plurality of obstacle detection units are connected to the communication line in sequence;
among the plurality of obstacle detection units, the foremost-stage obstacle detection unit is firstly ID-set in such a manner that a communication between the foremost-stage obstacle detection unit and the control unit is solely capable among communications between the plurality of obstacle detection units and the control unit;
the other obstacle detection units than the foremost-stage obstacle detection unit are sequentially communicated with the control unit to be ID-set, in such a manner that the communication between the control unit and the sequent-stage obstacle detection unit is made capable by the fore-stage obstacle detection unit which has been ID-set by the control unit;
based on an ID setting sequence of the plurality of obstacle detection units, the control unit assigns the plurality of obstacle detection units to the arrangement positions to identify the plurality of obstacle detection units;
the control unit performs an ID setting of the informing unit, with the switch being controlled by the control unit to make incapable the communication between the control unit and the foremost-stage obstacle detection unit; and
after the ID setting of the informing unit is completed, the switch is controlled by the control unit to make capable the communication between the control unit and the foremost-stage obstacle detection unit so that the ID setting of the plurality of obstacle detection units is sequentially performed.

12. The obstacle detection device according to claim 11, further comprising:
a power line; and
a GND line, the foremost-stage obstacle detection unit being power-supplied via the GND line and the power line, wherein
the switch is arranged at one of the power line and the GND line.

13. The obstacle detection device according to claim 11, wherein the switch is arranged between the control unit and the foremost-stage obstacle detection unit at the communication line.

14. The obstacle detection device according to claim 1, wherein
the informing unit is ID-set before being mounted at the vehicle.

15. The obstacle detection device according to claim 1, wherein the obstacle detection unit is constructed of a sensor.
